(19) United States
(12) Patent Application Publication
(10) Pub. No.: US 2025/0214031 A1
(43) Pub. Date: Jul. 3, 2025

(54) SYSTEM FOR GENERATING LIQUID WATER FROM AIR

(71) Applicant: University of South Africa, Pretoria (ZA)

(72) Inventor: Lukas Willem SNYMAN, Pretoria (ZA)

(21) Appl. No.: 19/085,742

(22) Filed: Mar. 20, 2025

Related U.S. Application Data
(63) Continuation of application No. PCT/ZA2023/050059, filed on Sep. 21, 2023.

(30) Foreign Application Priority Data
Sep. 21, 2022 (ZA) 2022/10435

(51) Int. Cl. B01D 53/26

(52) U.S. Cl. CPC B01D 53/265; B01D 2221/16; B01D 2257/80

(57) ABSTRACT

A system for generating liquid water from air is provided. The system includes an air current generating device and a body which allows a current of air from the air current generating device to flow therethrough. The body comprising a constricted portion through which the current of air passes from an inlet hereof to an outlet thereof, wherein cooled air that is at a temperature that is substantially at a dew point temperature of air is discharged at the outlet of the constricted portion thereby causing water in the air to condensate from the cooled air. A portion of the energy required to cool down the air is fed back to the input, requiring less energy to cool down air in subsequent cycles of air. Also provided is a corresponding method.

### CROSS REFERENCE TO RELATED APPLICATIONS

This application is a continuation of International Patent Application No. PCT/ZA2023/050059, filed Sep. 21, 2023, which takes priority from South African Patent Application No. 2022/10435, filed Sep. 21, 2022, the contents of each of which are incorporated by reference herein.

### FIELD OF THE INVENTION

This invention relates to a system for generating liquid water from air.

### BACKGROUND

There are already existing systems which produce water from air and several commercial units are on the market already. However, most of these systems use grid supply electricity to power the system or they make use of simple technologies such as freezing water on cooled copper coiled structures which is inefficient for generating large volumes of water. Furthermore, the energy needed to provide sufficient cooling to reach the dew point to allow the water vapor in air to condense is very high. Hence, the costs of running these systems are very high because of the high energy needed to create one liter of fresh water. In some instances, the technological complexity of these systems requires powerful and large compressors to operate, which again raises the production cost of the water per liter, making it very uneconomical. Therefore, the cost of producing fresh water from air when using the existing systems that are on the market is very high.

Various systems for generating liquid water from air are known, For example:

US2020/0346164 entitled “Method and device for obtaining water from ambient air” and describes a device for obtaining water from ambient air comprising at least one evaporator for generating water vapor from a diluted liquid absorbent, at least one condenser in operative connection with the at least one evaporator, wherein the at least one condenser includes at least one heat exchanger for condensation of the water vapor, at least one conveying device for conveying a cooling medium to the at least one heat exchanger for cooling the at least one condenser, and means for conveying heated cooling medium exiting from the at least one condenser to at least one device for large-area contacting of the heated cooling medium with the ambient air for cooling the heated cooling medium by means of the ambient air. The heat exchanger may be powered by solar power.

US2021/0156124 entitled “Active atmospheric moisture harvester” and describes an atmospheric moisture harvester system which includes two beds with water capture material, such as metal-organic framework (MOF), a heater, two fans, and a condenser having two sides, operatively configured into adsorption and desorption modes, wherein the MOF beds are interchangeable to cycle between the desorption and water adsorption modes. The system may further include a photovoltaic panel powering the fans and condenser.

U.S. Pat. No. 10,835,861 entitled “Systems and methods for generating liquid water from air” and describes a system for generating liquid water from air, the system comprising a housing defining an adsorption zone and a desorption zone, a desiccant selectively movable between the adsorption zone in which the desiccant is in fluid communication with a process airflow path such that the desiccant can capture water from air in the process airflow path, and the desorption zone in which the desiccant is in fluid communication with a regeneration fluid path such that the desiccant can release water to regeneration fluid in the regeneration fluid path. The system also includes an actuator configured to move the desiccant between the adsorption zone and the desorption zone, a first blower configured to adjust a flow rate of air through the process airflow path, and a circulator configured to adjust a flow rate of regeneration fluid through the regeneration fluid path. The system further includes a thermal unit comprising a casing in fluid communication with the regeneration fluid path and configured to provide thermal energy to regeneration fluid in the regeneration fluid path, a condenser configured to receive regeneration fluid from the desorption zone via the regeneration fluid path and to produce liquid water from regeneration fluid received from the desorption zone, a solar insolation sensor configured to capture data indicative of a level of solar insolation, and a controller configured to control a liquid water production rate by controlling at least one of: a blower speed of the first blower, a movement of the desiccant through the actuator, or a speed of the circulator, based, at least in part, on a signal received from the solar insolation sensor. An embodiment of the system further comprises a solar power unit configured to provide electrical power to the system.

A known drawback of these inventions is that they do not use a Venturi air compression and expansion system to enhance the condensation of water from air, furthermore, said inventions do not use a thermal feedback system between the condenser and exit gases in order to improve the efficiency of the water production process and reduce the cost of the water production process.

It is an object of the present invention to alleviate at least some of the disadvantages mentioned above.

### SUMMARY

Implementations of the present invention may overcome these problems by using a Venturi air compression and expansion system to enhance the condensation of water from air. By forcing air through a narrow tube with subsequent expansion of the air into a larger chamber, allows the air to cool at higher efficiency thereby reducing the system operating costs. Once the volume of air passes through the narrow tube it reaches the dew point and all water vapor present in the compressed air will condensate out from the cooled air.

According to one aspect of the invention, there is provided a system for generating liquid water from air which system includes:
an air current generating device;
a body which allows a current of air from the air current generating device to flow therethrough, the body comprising a constricted portion through which a current of air generated by the air current generating device passes from an inlet to an outlet of the constricted portion, wherein the cooled air that is at a temperature that is substantially at a dew point temperature of air is discharged at the outlet of the constricted portion thereby promoting the condensation of water from the cooled air.

The body may comprise:
a first end that is arranged in fluid flow communication with the inlet of the constricted portion; and
a second end that is in communication with an outlet of the constricted portion allowing cooled air to expand as it is discharged from the outlet of the constricted portion.

The air current generating device may be arranged in the first end of the body to allow ambient air to flow into the body via the first end of the body and enable the air current generating device to generate a current of air from the ambient air.

The cross-sectional area of the narrow portion is less than a cross-sectional area of the first end and the second end of the body, to allow the current of air flowing into the narrow portion to be compressed at the inlet thereof, and to allow compressed air flowing from the narrow portion through the outlet of the constricted portion to expand, as it is released from the outlet, to facilitate condensation of water from the cooled air.

The body may be in the form of a tubing.

The body may be manufactured from any suitable plastics and/or metallics material, preferably being manufactured from stainless steel.

The first end may have a cross-section of any suitable conventional geometric shape, preferably being generally circular. The first may have a diameter in the range of 1 m to 2 m, preferably being 1 m.

The second end may have a cross-section of any suitable conventional geometric shape, preferably being generally circular. The second may have a diameter in the range of 1 m to 2 m, preferably being 1 m.

The narrow portion may have a cross-section of any suitable conventional geometric shape, preferably being generally circular. The narrow portion may have a diameter in the range of 0.3 m to 0.5 m, preferably being 0.5 m. The narrow portion may be generally tubular in shape. The narrow portion may have a length in the range of 1 m to 3 m, preferably being 1 m.

The narrow portion may have a cross-section that is smaller/less than the cross-section of the first end.

The air current generating device may be a fan that may be in the form of a conventional fan, such a centrifugal or axial fan. The air current generating device may also be in the form of a blower.

The fan may be located in the first end of the body or arranged relative to the first end of the body so as drive a current of air into the first end of the body.

The system may include a cooling device fitted to the body to allow the current of air to be cooled as the air flows through the narrow portion of the body.

The cooling device may be arranged in the narrow portion of the body.

The cooling device may be in the form of a conventional coil cooling system. The system or the cooling device may include a fluid circulation system for circulating a cooling fluid through the cooling device, to facilitate cooling of the air. The cooling fluid may be in the form of a cooling refrigerant. The fluid circulation system may include a tubing system and a displacement means arranged in fluid flow communication with the tubing system, for displacing the cooling fluid through the tubing system (not shown) into the cooling device, to facilitate cooling the air. The displacement means may be in the form of a pump.

The body may have a water outlet on the second end of the body. The water outlet may have a cross-section of any suitable conventional geometric shape, preferably being generally circular. The water outlet may have a diameter in the range of 1 m to 10 m, preferably being 3 m. The water outlet may be generally tubular in shape. The water outlet may have a length in the range of 1 meter to 10 m, preferably being 1 m.

A heat extraction device may be arranged in fluid flow communication with the outlet of the constricted portion, in particular an outlet region extending from the second end of the body, and the cooling device, to allow the air to be further cooled, by extracting heat from the air, to further facilitate forming the water from the air.

The heat extraction device may include a heat fluid circulation system for circulating the cooling fluid through the heat extraction device, to further facilitate cooling of the air. In particular, the heat fluid circulation system may be arranged in fluid flow communication with the fluid circulation system, to allow the cooling fluid from the fluid circulation system to circulate through the heat fluid circulation system. The fluid circulation system may include a heat tubing system and the fluid displacement means arranged in fluid flow communication with the heat tubing system, for displacing the cooling fluid through the heat tubing system, to further facilitate cooling the air. It is to be appreciated that since the fluid circulation system and the heat fluid circulation system is arranged in fluid flow communication with each other, and the same cooling fluid flows through both systems, the same energy used by the cooling device to cool the air, is also used to enhance the heat extraction process in the heat extraction device. It is to be appreciated that this enhances the total efficiency and energy usage of the overall system for generating the water from the air.

A sensor arrangement may be provided for sensing a temperature of the air to determine an optimum water production period. It is to be appreciated that when the temperature of the air is close to dew point, an efficiency at which the water is formed from the air can be optimized. The sensor arrangement may be in the form of a temperature sensor. A controller may be arranged in electrical communication with the sensor arrangement for controlling the fan, cooling device and/or heat extraction device, in particular the fluid displacement means thereof, to optimize an efficiency at which the water is formed from the air.

A power generating means or an energizing means may be arranged in electrical communication with the fan, the cooling device, heat extraction device, sensor arrangement and/or controller, for providing power/energizing the fan to facilitate the flow of the air into the inlet and to allow the air to be cooled in the narrow portion and/or outlet, in particular the outlet region extending from the second end, of the body. The power generating means or the energizing means may be selected from the group including a wind turbine system, a photovoltaic (PV) solar cell arrangement, or a grid electricity power arrangement.

An additional enlarged condensation area may be arranged in fluid flow communication with the outlet of the body, to allow the air flowing out of the body that was cooled by the cooling device to condensate over a larger surface area, further enhancing the forming of the water from the air. The additional enlarged condensation area may be in the form of a modified conventional greenhouse.

According to another aspect of the invention there is provided a method of generating water from air, the method including:
passing a current of air through a constricted portion of a body; and
collecting condensate and cooled air as the current of air flowing through the constricted portion expands as it is discharged into an enlarged portion of the body that is in fluid communication with the constricted portion.

The method may include contacting the current of air with a cooling device while the current of air is passed through the constricted portion, to further decrease the temperature of the current of air to a dew point temperature.

### BRIEF DESCRIPTION OF THE DRAWINGS

A system for generating liquid water from air in accordance with the invention will now be described by way of the following, non-limiting examples with reference to the accompanying drawings.

In the drawings:

FIG. 1 is a schematic of a system for generating liquid water from air in accordance with the present invention;

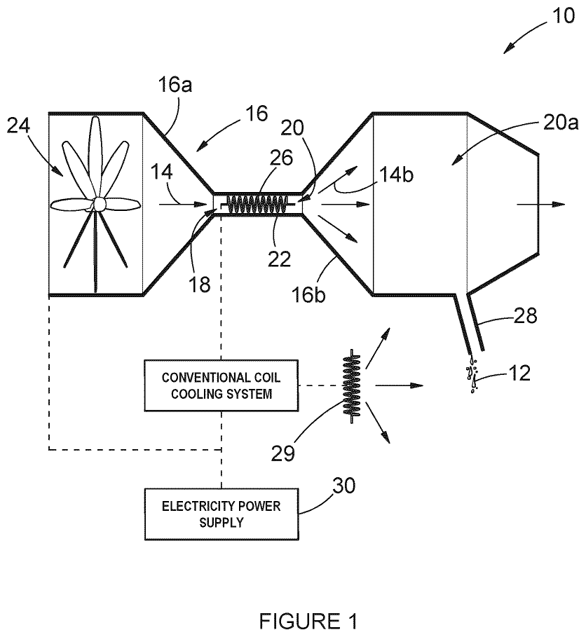

FIG. 2 is a schematic of the system for generating liquid water from air as shown in FIG. 1, wherein the heat exchange system is arranged in fluid flow communication with the outlet of the body and the energy used in the narrow portion to cool air is further used to enhance the heat extraction process of the heat exchange coil, now placed in fluid flow communication with the outlet of the body;

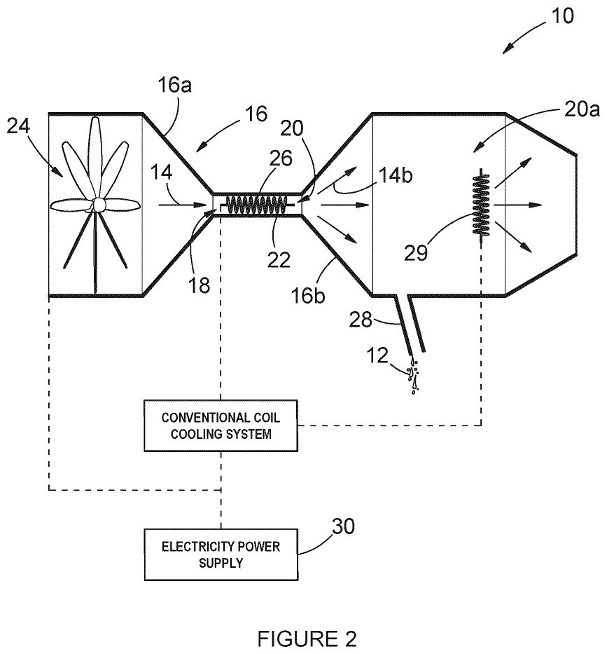

FIG. 3 is a schematic of the system for generating liquid water from air as shown in FIG. 2, wherein the energizing means is in the form of a photovoltaic (PV) solar cell arrangement;

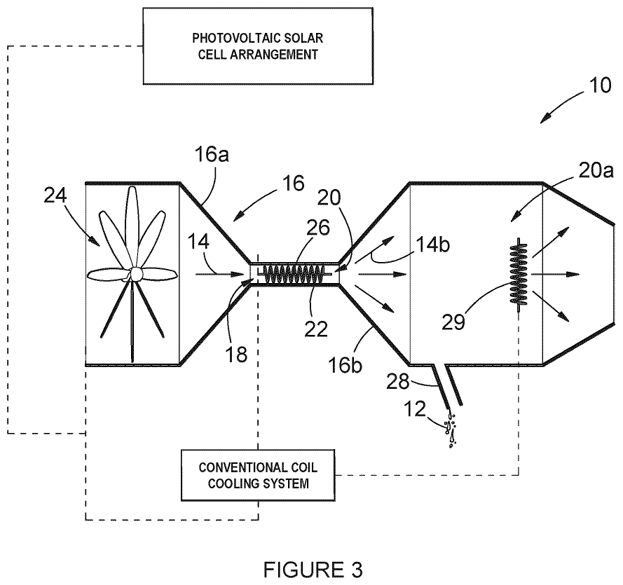

FIG. 4 is a schematic of the system for generating liquid water from air as shown in FIG. 2, wherein the energizing means is in the form of a wind turbine system; and

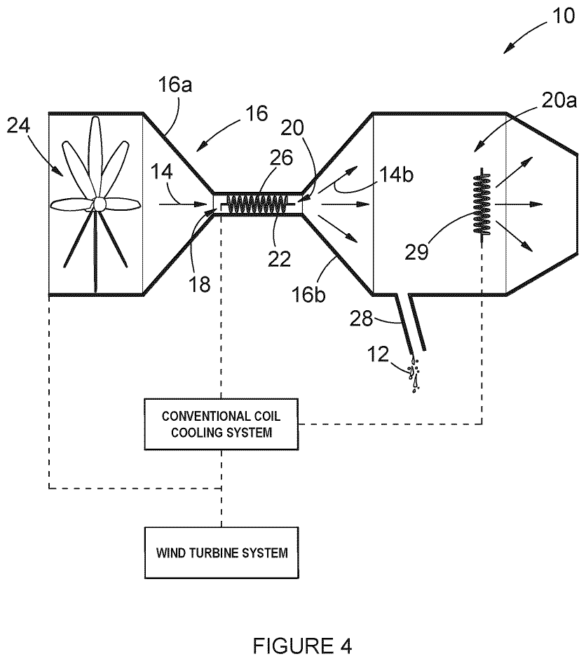

FIG. 5 is a schematic of the system for generating liquid water from air as shown in FIG. 2, wherein an additional enlarged condensation area is arranged in fluid flow communication with the outlet of the body, wherein the additional enlarged condensation area is in the form of a modified conventional green house.

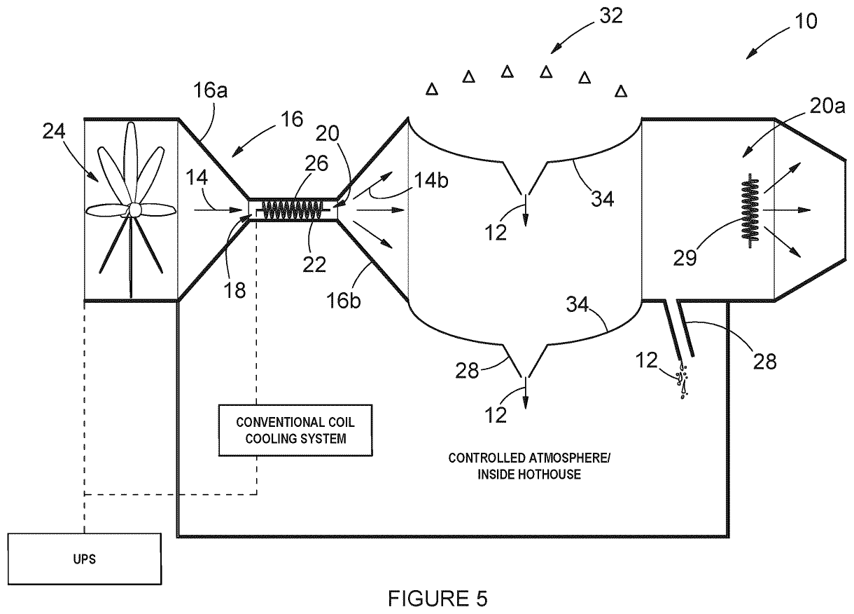

### DETAILED DESCRIPTION OF THE PREFERRED EMBODIMENTS

Referring now to the drawings reference numeral 10 refers generally to a system for generating liquid water 12 from air 14 which system 10 includes a body 16 which allows air 14 to flow therethrough, wherein the body 16 comprises a first end 16a of the body 16 to allow air 14 to flow into the body 16, an opposing second end 16b of the body 16 to allow air 14 to flow out of the body 16, and a narrow/constricted portion 22 having an inlet 18 and an outlet 20 arranged in fluid flow communication with the first and second opposing ends 16a, 16b of the body 16, wherein a cross-sectional area of the narrow portion 22 is less than a cross-sectional area of the first end 16a and the second end 16b, to allow the air 14 flowing from the inlet 18 into the narrow portion 22 to be compressed, and to allow compressed air 14b flowing from the narrow portion 22 through the outlet 20 to be subsequently expanded to facilitate forming water 12 from the air 14, a fan 24 arranged in fluid flow communication with the inlet 18 to allow the current of air 14 to flow into the inlet 18, a cooling device 26 arranged in the narrow portion 22 of the body 16 to allow the current of air 14 to be cooled while it is being compressed as the air 14 flows through the narrow portion 22 of the body 16, and a water outlet 28 arranged in fluid flow communication with the second end 16b of the body 16 to allow water 12 that is formed from the air 14 to flow through the water outlet 28.

The body 16 is manufactured from any suitable plastics or metallics material, typically being manufactured from stainless steel.

The first end 16a has a cross-section of any suitable conventional geometric shape, typically being generally circular. The first end 16a has a diameter in the range of 1 m to 2 m, typically being 1 m.

The second end 16b has a cross-section of any suitable conventional geometric shape, typically being generally circular. The second end 16b has a diameter in the range of 1 m to 2 m, typically being 1 m.

The narrow portion 22 has a cross-section of any suitable conventional geometric shape, typically being generally circular. The narrow portion 22 has a diameter in the range of 0.3 m to 0.5 m, typically being 0.5 m. The narrow portion 22 is generally tubular in shape. The narrow portion 22 has a length in the range of 1 m to 3 m, typically being 1 m. The fan 24 is in the form of a suitable conventional fan.

The cooling device 26 is in the form of a conventional coil cooling system. The cooling device 26 includes a fluid circulation system (not shown) for circulating a cooling fluid (not shown) through the cooling device 26, to facilitate cooling of the air 14. The cooling fluid (not shown) is in the form of a cooling refrigerant. The fluid circulation system (not shown) includes a tubing system (not shown) and a displacement means (not shown) arranged in fluid flow communication with the tubing system (not shown), for displacing the cooling fluid (not shown) through the tubing system (not shown), to facilitate cooling of the air 14. The displacement means (not shown) is in the form of a pump.

The water outlet 28 has a cross-section of any suitable conventional geometric shape, typically being generally circular. The water outlet 28 has a diameter in the range of 1 m to 10 m, typically being 3 m. The water outlet is generally tubular in shape. The water outlet 28 has a length in the range of 1 m to 10 m, typically being 1 m.

A heat extraction device 29 is arranged in fluid flow communication with the outlet 20 of the narrow portion 22, in particular an outlet region 20a extending from the opposing second end 16b of the body 16, and the cooling device 26 to allow the air 14 to be further cooled, by extracting heat from the air 14, to further facilitate forming the water 12 from the air 14. The heat extraction device 29 includes a heat fluid circulation system (not shown) for circulating the cooling fluid (not shown) through the heat extraction device 29, to further facilitate cooling of the air 14. In particular, the heat fluid circulation system (not shown) is arranged in fluid flow communication with the fluid circulation system of the cooling device 26 (not shown), to allow the cooling fluid (not shown) from the fluid circulation system (not shown) to circulate through the heat circulation system (not shown). The heat fluid circulation system (not shown) includes a heat tubing system (not shown) and the fluid displacement means (not shown) arranged in fluid flow communication with the heat tubing system (not shown), for displacing the cooling fluid (not shown) through the heat tubing system (not shown), to further facilitate cooling the air 14. It is to be appreciated that the since the fluid circulation system (not shown) and the heat fluid circulation system (not shown) is arranged in fluid flow communication with each other, and the same cooling fluid (not shown) flows through both systems, the same energy used by the cooling device to cool the air 14, is also used to enhance the heat extraction process in the heat extraction device 29. It is to be appreciated that this enhances the total efficiency and energy usage of the overall system for generating the water 12 from the air 14.

An energizing means 30 is arranged in electrical communication with the fan 24 and the cooling device 26, heat extraction device 29, sensor arrangement (not shown) and controller (not shown), for energizing the fan 24 to facilitate the flow of the air 14 (i.e. generate a current of air) into the inlet 18 and to allow the air 14 to be cooled in the narrow portion 22 and outlet 20, in particular the outlet region 20a extending from the opposing end 16, of the body 16. The energizing means 30 is selected from the group including a wind turbine system, a photovoltaic (PV) solar cell arrangement, or a grid electricity power arrangement.

A sensor arrangement (not shown) is provided for sensing a temperature of the air 14 to determine an optimum water production period. It is to be appreciated that when the temperature of the air 14 is close to dew point, an efficiency at which the water 12 is formed from the air 14 can be optimized. The sensor arrangement (not shown) is in the form of a temperature sensor. A controller (not shown) is arranged in electrical communication with the sensor arrangement (not shown) for controlling the fan 24, cooling device 26 and heat extraction device 29, in particular the fluid displacement means (not shown) thereof, to optimize an efficiency at which the water 12 is formed from the air 14.

An additional enlarged condensation area 32 is arranged in fluid flow communication with the outlet 20 of the narrow portion 22, to allow the air 14 flowing out of the body 16 that was cooled by the cooling device 26 to condensate over a larger surface area 34, further enhancing the forming of the water 12 from the air 14. The additional enlarged condensation area 32 is in the form of a modified conventional greenhouse.

It is, of course, to be appreciated that the system for generating liquid water from air in accordance with the invention is not limited to the precise constructional and functional details as hereinbefore described with reference to the accompanying drawings and which may be varied as desired.

Although only certain embodiments of the invention have been described herein, it will be understood by any person skilled in the art that other modifications, variations, and possibilities of the invention are possible. Such modifications, variations and possibilities are therefore to be considered as falling within the spirit and scope of the invention and hence form part of the invention as herein described and/or exemplified. It is further to be understood that the examples are provided for illustrating the invention further and to assist a person skilled in the art with understanding the invention and is not meant to be construed as unduly limiting the reasonable scope of the invention.

The inventor(s) believes that the system for generating liquid water from air in accordance with the present invention is advantageous in that it allows the cost of production per liter of water from air to be reduced over a 20 year lifetime of the system.

What is claimed is:

1. A system (10) for generating liquid water from air, the system (10) including:
an air current generating device (24) for generating a current of air;
a body (16) comprising a first end (16a) and a second end (16b), and a constricted portion (22) extending between the first and second ends (16a, 16b), wherein the current of air passes through the constricted portion (22) from the first end (16a) to the second end (16b) of the body (16), wherein the second end (16b) of the body (16) is configured to allow cooled air at a temperature that is substantially at a dew point temperature of air to expand as it is discharged from an outlet (20) of the constricted portion (22), thereby causing water in the expanding cooled air to condensate from the cooled air;
a cooling device (26) accommodated in the constricted portion (22) for cooling the current of air flowing through the constricted portion (22); and
a heat extraction device (29) that is in fluid communication with the cooling device (26), wherein the heat extraction device (26) is located downstream from the cooling device (26) to allow the cooled air to cool a cooling fluid contained in the heat extraction device (29).

2. The system of claim 1, wherein the air current generating device (24) is arranged in the first end (16a) of the body (16) or relative to the first end (16a) of the body (16) to drive the current of air into an inlet (18) of the constricted portion (22) which is in fluid communication with the first end (16a) of the body 16).

3. The system of claim 2, wherein the cross-sectional area of the constricted portion (22) is less than the cross-sectional area of the first and second ends (16a, 16b) of the body (16), to allow the current of air to be compressed at the inlet (18) thereof, and to allow compressed air flowing from the constricted portion (22) through the outlet (20) thereof to expand, as it is released from the outlet (20) thereof into the second end (16b) of the body (16), to facilitate condensation of water from the cooled air.

4. The system of claim 1, further comprising a water outlet (28) arranged in fluid flow communication with the outlet (20) of the constricted portion (22).

5. The system of claim 1, further comprising a fluid circulation system for circulating the cooling fluid between the cooling device (26) and the heat extraction device (29).

6. The system of claim 1, further comprising a sensor arrangement for sensing the temperature of the current of air flowing through the body (16) to determine an optimum water production period.

7. The system of claim 6, further comprising a power generating means for providing power to the air current generating device (24), the cooling device (26), heat extraction device (29), and sensor arrangement.

8. The system of claim 1, wherein the body (16) is constructed from plastic materials.

9. The system of claim 1, wherein the body (16) is constructed from steel materials, in particular stainless steel.

10. A method of generating water from air, the method including:
passing a current of air through a constricted portion (22) of a body (16) accommodating a cooling device (26);
contacting the current of air in the constricted portion (22) of the body (16) with cooling fluid in the cooling device (26) to obtain a cooled current of air;
expanding the cooled current of air so as to form condensate from the cooled air;
displacing the cooling fluid from the cooling device (26) into a heat extraction device (29) downstream the cooling device;
contacting the cooled air from the constricted portion (22) with the cooling fluid displaced into the heat extraction device (29);
recirculating the cooling fluid from the heat extraction device (29) back into the cooling device (26) for further cooling the current of air passing through the constricted portion (22) of the body (16); and
collecting the condensate.
